(19) United States
(12) Patent Application Publication
(10) Pub. No.: US 2004/0221428 A1
(43) Pub. Date: Nov. 11, 2004

(54) Multiple-purpose clip with gripping members

(75) Inventor: Keith Alan Johnson, Bronson, MI (US)

Correspondence Address: Jennifer Moss, 120 Mill Street, Bronson, MI, 49028-1016, US

(73) Assignee: Keith Alan Johnson

(21) Appl. No.: 10/429,468

(22) Filed: May 5, 2003

(51) Int. Cl. B42F 1/02

(52) U.S. Cl. 24/67.9

(57) ABSTRACT

A decorative single-piece, dual-level clip comprising a flexible outer frame and a central platform that attaches along a short segment to the flexible outer frame. Paper or other material may be slipped into the horizontal gap between the central platform and outer frame. Gripping members on the front of the outer frame aid the present invention in firmly holding onto material. Ornamentation appearing on the central platform can vary in shape and method of application. Depending on the shape and kind of ornamentation, the present invention may also be used as a stencil, as well as a learning tool. This clip is intended to be functional and ornamental.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention generally relates to a new style of clip and more specially, but not exclusively limited to a paper clip that is to be slipped onto one or many sheets of paper or other material as a functional adornment. This clip can be easily attached and removed from material, yet holds itself in place sufficiently while contributing aesthetically to the overall appearance of the material it grips.

People often enjoy adding individual expression to correspondence that is expressed on paper; some use personalized stationery, while others affix stickers or other objects of adornment to their letters. The problem with these outlets of personal expression is that they most likely have no practical value.

Conversely, when the need arises to temporarily fasten together several sheets of paper, the paper clips most often used are purely functional and have little or no aesthetic value.

There have been many pursuits to improve upon the traditional coiled metal paper clip. As it has become increasingly popular to use plastic in manufacturing instead of metal, it is only natural that the composition of the paper clip would evolve to plastic as well. The problem with modern plastic paper clips is that they tend to slip off of paper rather easily. Some inventors have attempted to remedy this issue by adding small ribs or textured surfaces to their paper clips. However, ribs or textured surfaces are not substantial enough in size to make much of a difference in the gripping capability of a plastic paper clip.

Also, most new designs are merely adaptations of the traditional paper clip; being more extensive in length than in width, or being a differently configured coil, or the entire clip being on one flat plane, etc. The innovation in creating new, types of paper clips has been sparse.

### BRIEF SUMMARY OF THE INVENTION

The paper clip of the present invention will henceforth be referred to as the “Modern Clip”. The Modern Clip is a decorative single-piece, dual-level apparatus comprising a flexible outer frame and a central platform that attaches along a short segment, or “spine,” to the flexible outer frame. Ornamentation appears on the central platform. A horizontal gap between the outer frame and central platform is large enough to accommodate the insertion of one or more sheets of paper or other material. The inserted material rests against the spine. Protruding upward from the front surface of the outer frame are several conspicuous gripping members that firmly press against the rear of inserted material, thus holding itself in place. The Modern Clip can be made of plastic or metal.

An object of the present invention is to provide a clip that is capable of effectively holding material and sustaining its grip for the duration of time desired by the user.

It is furthermore an object of the present invention not only to effectively hold material, but also to offer an aesthetic contribution to the overall appearance of said material.

Another object of the present invention is to be entertaining and educational by designing the Modern Clip in such a way that it can be used as an award for students or the ornamentation within the central platform might be used as a stencil.

And yet another object of the present invention is to provide a clip that does not move about once it has been attached to material by using gripping members to press against the surface of material.

And still another object of the present invention is to provide a clip that is inexpensive to manufacture and affordable for the end user to purchase.

Another object of the present invention is to provide a clip that can be used as an ornament to adorn stationary, clothing, and other objects.

And yet another object of the present invention is to provide a clip having an endless number of possible embodiments, thus, allowing the look of the Modern Clip to be adapted to suit special themes, holidays, or other occasions while remaining true to the principles of the invention.

### BRIEF DESCRIPTION OF THE SEVERAL VIEWS OF THE DRAWING

FIG. 1 is a perspective view of an embodiment of the Modern Clip with ornamentation in the shape of a clover on the surface of the central platform and several circular gripping members on the outer frame.

FIG. 2 is a side-rear view of an embodiment of the Modern Clip shown in FIG. 1 with several circular gripping members on the rear of the central platform.

FIG. 3 is a front view of an embodiment of the Modern Clip with ornamentation on the surface of the central platform in the shape of a smiling face and several circular gripping members on the outer frame.

FIG. 4 is a rear view of an embodiment of the Modern Clip shown in FIG. 3 with several circular gripping members on the rear of the central platform.

FIG. 5 is a front view of an embodiment of the Modern Clip with a heart-shaped central platform and ornamentation in the form of hearts on the surface of the central platform and several circular gripping members on the outer frame.

FIG. 6 is a front view of an embodiment of the Modern Clip with the central platform and outer frame being square in shape with ornamentation on the surface of the central platform in the form of a tree and stars.

FIG. 7 is a front view of an embodiment of the Modern Clip with the central platform and outer frame being triangular in shape with ornamentation on the central platform in the form of a number “7” and triangular-shaped gripping members on the outer frame.

FIG. 8 is a front view of an embodiment of the Modern Clip with the central platform being star-shaped and the outer frame being rectangular in shape with ornamentation on the central platform in the form of a letter “K” and star-shaped gripping members on the outer frame.

FIG. 9 is a side view of an embodiment of the Modern Clip with the central platform having a flat front surface with arced edges, the outer frame and spine having arced front and rear surfaces and a straight edge, and gripping members on the outer frame.

FIG. 10 is a side view of an embodiment of the Modern Clip with the central platform, outer frame, and spine having arced surfaces and edges.

FIG. 11 is a side view of an embodiment of the Modern Clip with the central platform, outer frame and spine having flat surfaces and arced edges.

FIG. 12 is a side view of an embodiment of the Modern Clip with the central platform, outer frame and spine having flat surfaces and edges.

FIG. 13 is a side view of an embodiment of the Modern Clip with the central platform having a flat front surface with arced edges, the outer frame and spine having arced front and rear surfaces and a straight edge and the spine having an extended height.

FIG. 14 is a perspective close-up view of an embodiment of a gripping member that is circular in shape with a pointed tip.

FIG. 15 is a perspective close-up view of an embodiment of a gripping member that is star-shaped with a pointed tip.

FIG. 16 is a perspective close-up view of an embodiment of a gripping member that is circular in shape with a smiling face and flat tip.

FIG. 17 is a perspective close-up view of an embodiment of a gripping member that is square in shape with a flat tip.

### DETAILED DESCRIPTION OF THE INVENTION

With reference to the drawings, which illustrate various embodiments of the present invention, but are not intended to confine the embodiments of the present invention to those of the drawings; the construction of the present invention can be modified while remaining true to its principles.

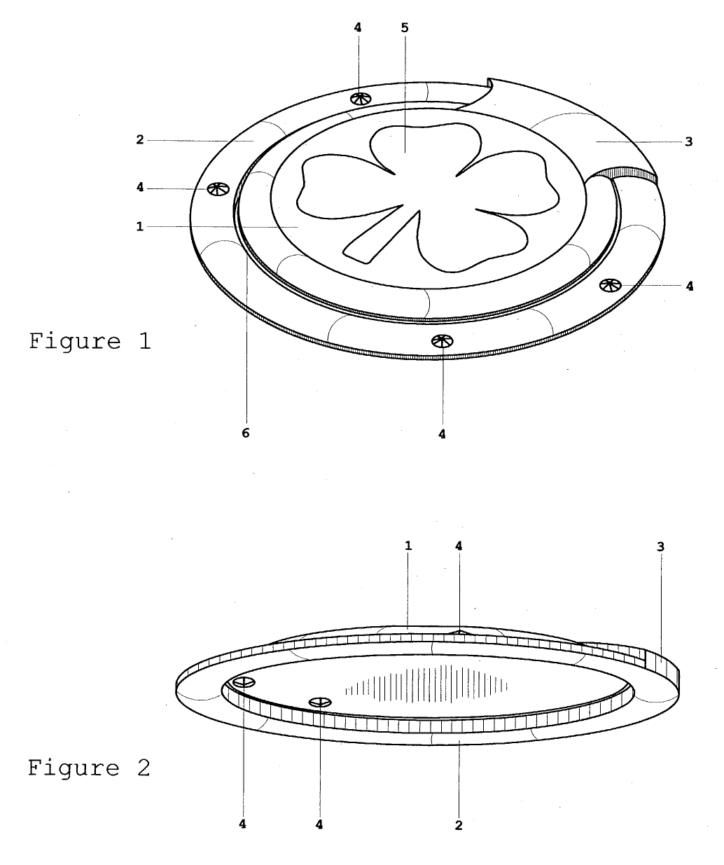

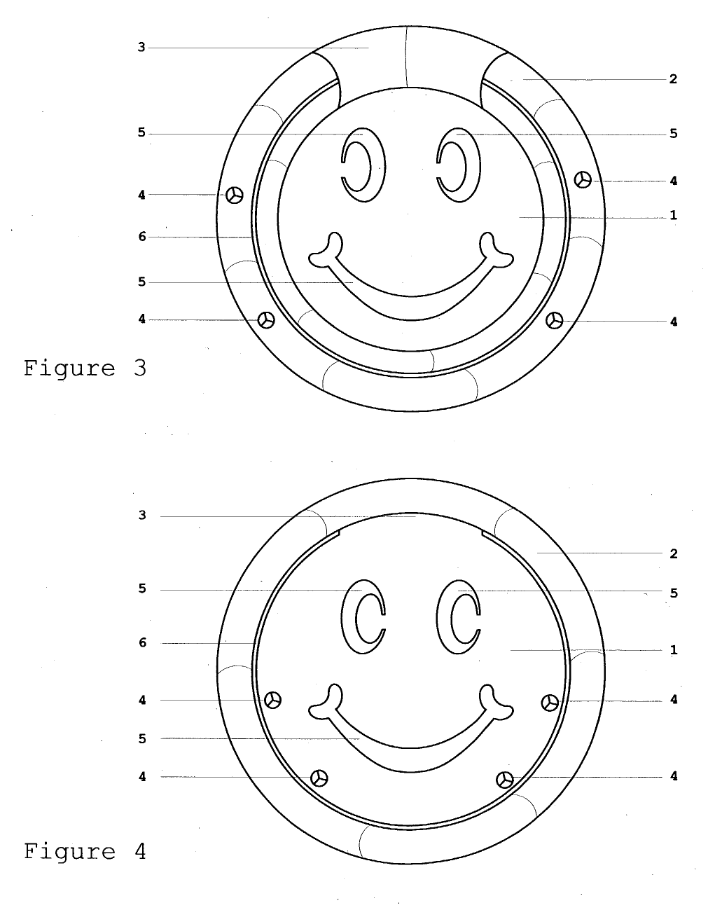

FIGS. 1, 2, 3, and 4 illustrate a generally circular embodiment of the Modern clip presenting a perspective view, side-rear view, front view, and rear view respectively. The Modern Clip has a central platform 1 on an upper plane and an outer frame 2 on a lower plane that attaches along the spine 3. The front surface of the central platform is flat in the middle and develops into an are around its outer perimeter curving downward, joining its edge, which is a vertical straight line that joins with the flat rear surface of the central platform. The front and rear surfaces of the outer frame are arced and join at the top and bottom edges by a straight line that travels the perimeter of the outer frame. The spine begins on the flat front surface of the central platform and arcs toward the top-rear of the Modern Clip, attaching to the outer frame. Circular gripping members 4 are located on the front of the outer frame in FIGS. 1 and 3, and on the rear of the central platform in FIGS. 2 and 4. The gripping members aid the Modern Clip in holding itself in place by extending beyond the surfaces they attach to and by having a pointed tip. The drawing in FIG. 1 illustrates ornamentation 5 in the shape of a hot-stamped clover on the central platform. The drawings in FIGS. 3 and 4 illustrate ornamentation 5 in the shape of a smiling face that forms cavities all the way through the central platform. This ornamentation adds to the aesthetic value of the clip. Furthermore, the method of ornamentation illustrated in FIGS. 3 and 4 generates a further use of this Modern Clip as a stencil, in addition to its other functions. Referring to FIGS. 1, 3 and 4 a vertical gap 6 is between the central platform and the outer frame.

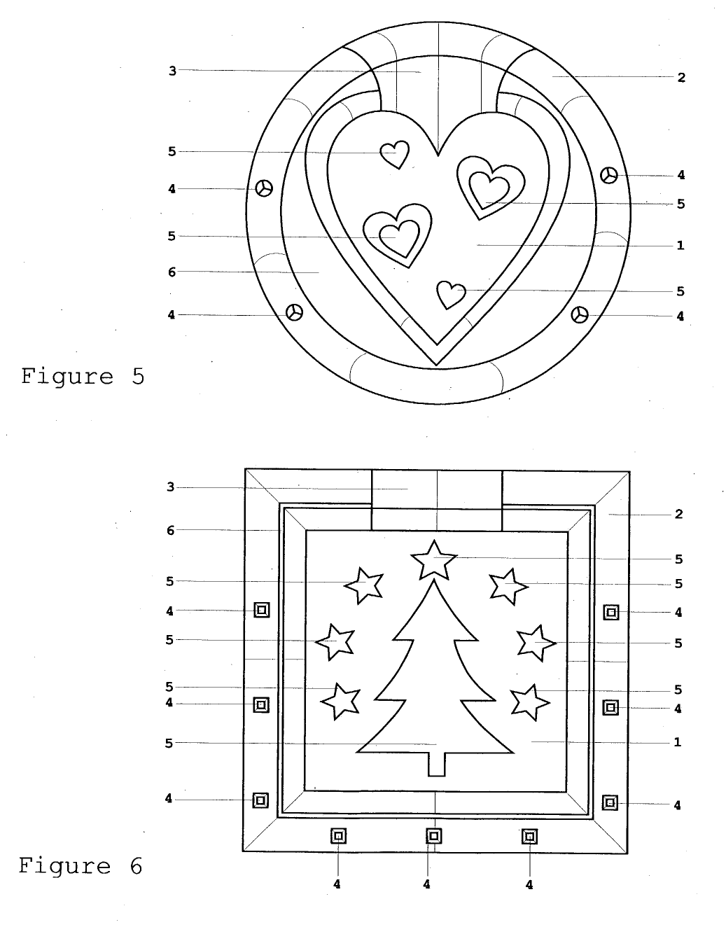

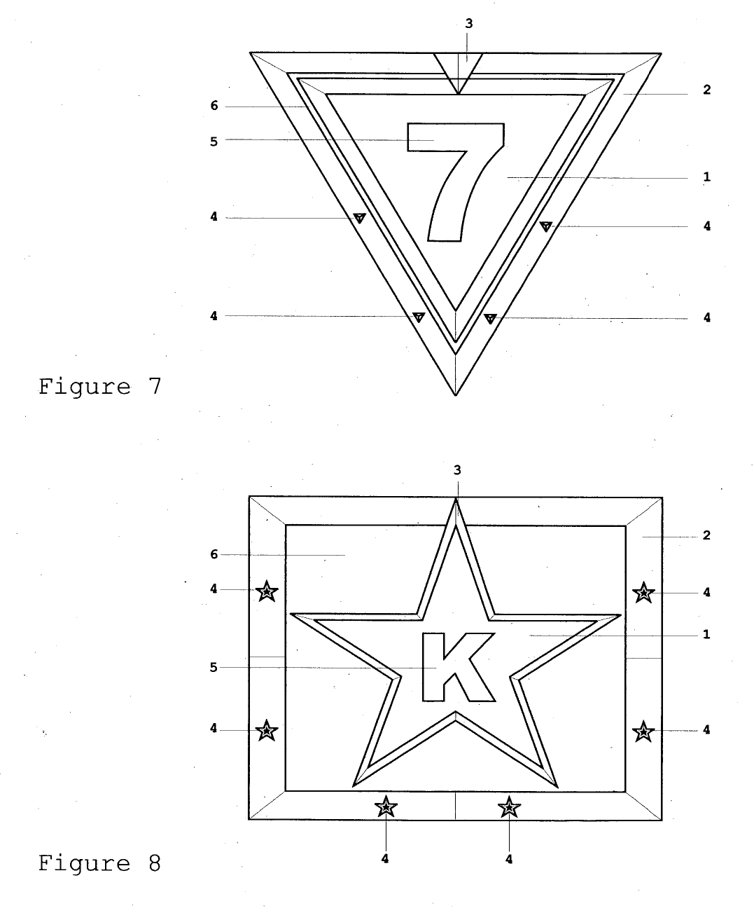

FIGS. 5, 6, 7, and 8 illustrate several differing embodiments of the Modern Clip having an central platform 1 that is heart shaped, square, triangular, and star-shaped and an outer frame 2 that is circular, square, triangular, and rectangular respectively. Referring to FIG. 5, the gripping members 4 are circular in shape, while the ornamentation 5 is in the shape of hearts forming pockets partially through the surface of the central platform. The vertical gap 6 is between the central platform and outer frame. The spine joins the central platform and arcs toward the top-rear of the Modern Clip attaching to the outer frame. Referring to FIG. 6, the gripping members are square in shape with flat tips while the general shape of the entire Modern Clip is angular, as opposed to curved. The ornamentation 5 on the front of the central platform illustrates a pad-printed tree and stars. The spine is rectangular. Referring to FIG. 7, the gripping members 4 are triangular in shape with pointed tips. The spine 3 is triangular in shape. Referring to FIGS. 7 and 8, the ornamentation 5 is in the shape of the number seven and letter “K” respectively and forms a cavity all the way though the central platform. This ornamentation in particular adds to the educational value of the Modern Clip, which can be used as an aid in teaching children how to perform simple mathematical calculations. It can additionally be used as a stencil to aid in teaching children how to write. Referring to FIG. 8, the gripping members 4 are star-shaped and have pointed tips. The gap 6 is between the central platform and outer frame. The spine begins as a part of the central platform and attaches vertically to the outer frame.

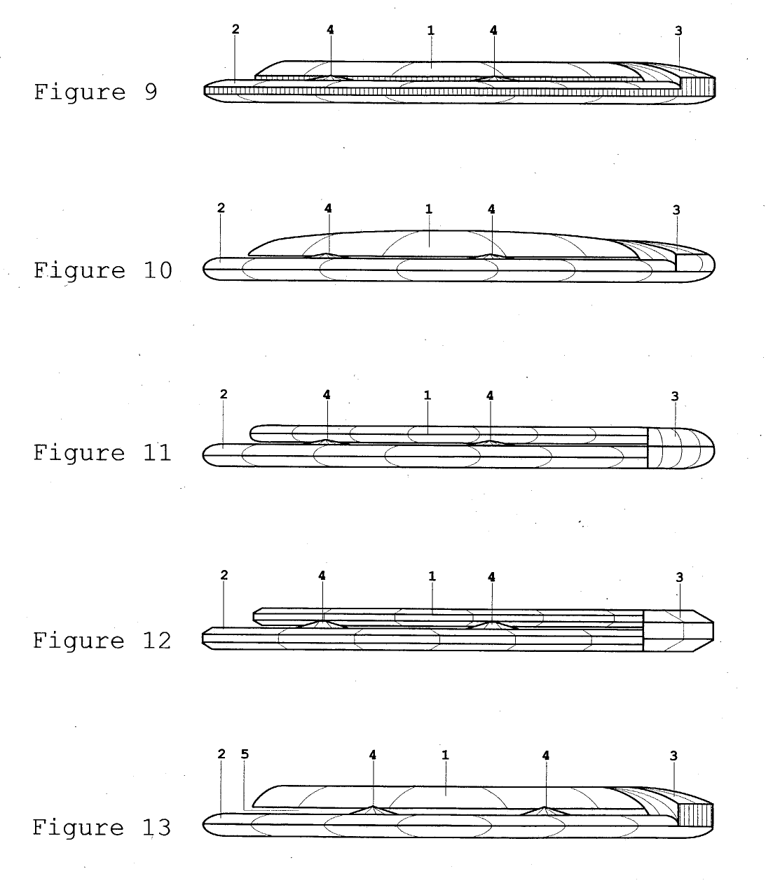

FIGS. 9, 10, 11, 12, and 13 illustrate differing embodiments of the Modern Clip with variations in the surfaces. Referring to FIG. 9, the front surface of the central platform 1 is flat in the middle and develops into an arc around its outer perimeter curving downward, joining its edge, which is a vertical straight line that joins with the flat rear surface of the central platform. The front and rear surfaces of the outer frame 2 are arced and join at the top and bottom edges by a straight line that travels the perimeter of the outer frame. The spine 3 begins on the flat front surface of the central platform and arcs toward the top-rear of the Modern Clip, attaching to the outer frame. The gripping members 4 are circular in shape having pointed tips. Referring to FIG. 10, the central platform 1 has a front surface that is entirely arced and a rear surface that is flat. The outer frame 2, as well as the spine 3 has arced surfaces and edges. The gripping members 4 are circular in shape having pointed tips. Referring to FIG. 11, the central platform 1, as well as the outer frame 2 and spine 3, has flat front and rear surfaces and arced edges. Referring to FIG. 12, the central platform 1, as well as the outer frame 2 and spine 3, has flat front and rear surfaces, and angled flat edges. The gripping members have flat tips. Referring to FIG. 13, the front surface of the central platform 1 is flat in the middle and develops into an arc around its outer perimeter curving downward, joining an arced edge, which joins the flat rear surface of the central platform. The spine 3 is slightly extended to increase the height of the horizontal gap 5 between the central platform and outer frame, which will allow the Modern Clip to accommodate the gripping of thicker material. An extension of the spine may cause the bottom edge of the central platform to dip downward slightly.

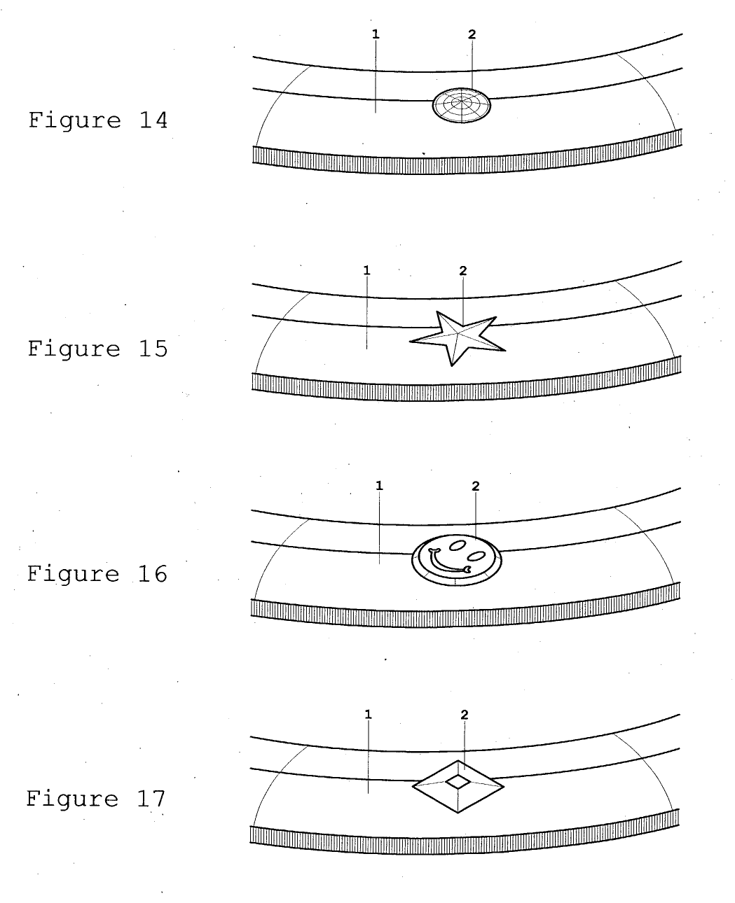

FIGS. 14, 15, 16, and 17 illustrate close-up views of differing embodiments of the Modern Clip's gripping members 2 on the outer frame 1. Referring to FIG. 14, the gripping member 2 is circular in shape having a pointed tip. Referring to FIG. 15, the gripping member 2 is star-shaped with a pointed tip. Referring to FIG. 16, the gripping member 2 is circular in shape having a flat tip with a smiling face. Referring to FIG. 17, the gripping member 2 is square in shape with a flat, square tip.

What I claim as my invention is:

1. A Modern Clip comprising:
a central platform surrounded by an outer frame whereas said central platform is located on an upper plane while said outer frame is located on a lower plane;
said central platform and said outer frame are joined by a spine extending from one segment of said central platform and connecting to a segment of said outer frame;
the joining of said central platform and said outer frame by said spine creates a horizontal gap between said central platform and said outer frame large enough to accommodate the insertion of paper or other material;
said central platform is smaller in length from front to back and width from side to side than said outer frame, thus forming a vertical gap between said central platform and said outer frame;
the continuation of said horizontal gap and said vertical gap is interrupted in one section by said spine that serves as a wall against which inserted paper or other material may rest;
said central platform having ornamentation on the front;
surface of said outer frame having multiple conspicuous, distinctive protrusions extending upward taking the form of gripping members that are expressly intended to press against paper or other material that is inserted into said horizontal gap to assist in holding said clip in place.

2. The Modern Clip according to claim 1, wherein the rear surface of said central platform having multiple conspicuous, distinctive protrusions extending downward taking the form of gripping members that are expressly intended to press against paper or other material that is inserted into said horizontal gap to assist in holding said Clip in place.

3. The Modern Clip according to claim 1, wherein said Clip is made of plastic or metal.

4. The Modern Clip according to claim 1, wherein the embodiment of said central platform, said outer frame, and said gripping members may be of varying incongruent shapes, thus, the embodiment of said central platform may be of a differing shape than that of said outer frame.

5. The Modern Clip according to claim 1, wherein said central platform, said outer frame, and said spine may have arced edges, flat edges, or a combination thereof.

6. The Modern Clip according to claim 1, wherein front, rear, side, top or bottom surfaces of said central platform, said outer frame, and said spine may be flat, arced, or a combination thereof.

7. The Modern Clip according to claim 1, wherein the front tip of said gripping members may be pointed, flat, or arced.

8. The Modern Clip according to claim 1, wherein said central platform having said ornamentation that is engraved, hot stamped, written, pad printed, displayed on an external surface which is affixed upon that of said central platform, raised from surface, a cavity that pierces entirely through said central platform, a pocket that penetrates partially through said central platform, or a combination thereof.

9. The Modern Clip according to claim 1, wherein said ornamentation forming a cavity through said central platform in the shape of numbers, letters, or other symbols that may be used as a stencil for tracing said ornamentation with a writing instrument onto another surface.
